(19) United States
(12) Patent Application Publication
(10) Pub. No.: US 2016/0178824 A1
(43) Pub. Date: Jun. 23, 2016

(54) BACKLIGHT ASSEMBLIES WITH DISTRIBUTED PHOSPHOR PATTERNS

(71) Applicant: Whirlpool Corporation, Benton Harbor, MI (US)

(72) Inventors: NEOMAR GIACOMINI, BENTON HARBOR, MI (US); BRIAN N. RADFORD, STEVENSVILLE, MI (US)

(73) Assignee: Whirlpool Corporation, Benton Harbor, MI (US)

(21) Appl. No.: 14/575,243

(22) Filed: Dec. 18, 2014

(51) Int. Cl. F21V 8/00

(52) U.S. Cl. CPC G02B 6/0003; G02B 6/0073; G02B 6/0068; G02B 6/0083

(57) ABSTRACT

An example backlight assembly comprises a diffusion panel, a light source, and a phosphor layer. The light source is located on a portion of a peripheral edge of the diffusion panel and emits light into the diffusion panel through the peripheral edge and emits light through a surface of the diffusion panel.

### BACKGROUND

User interfaces on devices typically have a display, such as a flat panel display, having a liquid crystal display, LCD, with a backlight. The backlight may be a florescent tube light or an LED light array. In a known configuration, the backlight extends along at least one edge of a diffusion panel behind the LCD. At least some of the light emitted from the backlight is directed by the backlight panel through the LCD.

### SUMMARY

A backlight assembly comprising a diffusion panel having a peripheral edge and a surface. A light source is located on a portion of the peripheral edge and emitting light into the diffusion panel through the peripheral edge and emitted through the surface. A phosphor layer is provided on the panel in the form of a pattern of dots formed of a material comprising phosphor, wherein the area of the diffusion panel covered by the dot pattern increases as a function of the distance from the light source.

### BRIEF DESCRIPTION OF THE FIGURES

In the drawings:

FIG. 1 is a bottom view of a first embodiment of a backlight assembly.

FIG. 2 is a schematic view of a light transformation, which may be used with the backlight assembly of FIG. 1.

FIG. 3 is a cross sectional side view of a second embodiment of a backlight assembly.

FIG. 4 is a bottom view of the second embodiment of the backlight assembly.

FIG. 5 is a cross sectional side view of the second embodiment of a backlight assembly with phosphor.

FIG. 6 is a bottom view of the second embodiment of the backlight assembly with phosphor.

### DETAILED DESCRIPTION

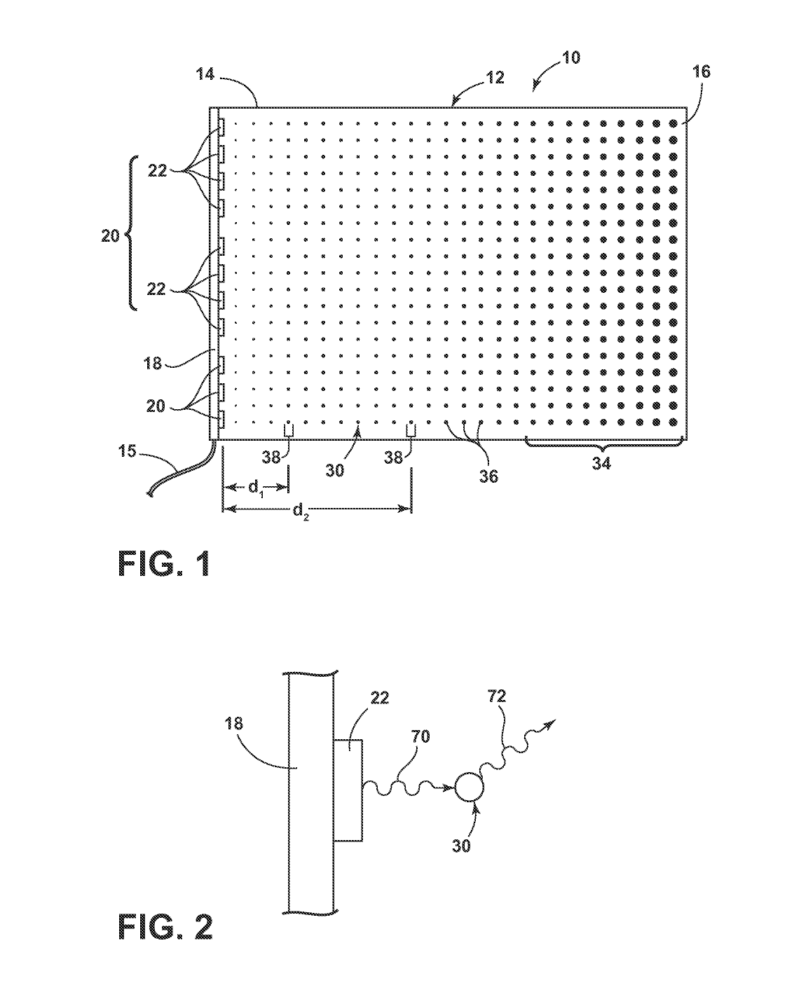

Referring to FIG. 1, a backlight assembly 10 comprises a diffusion panel 12 having a peripheral edge 14 bounding a surface 16. A light source 20 is disposed along at least a portion of the peripheral edge 14, and provided power via a power cable 15. A phosphor layer 30 is provided on the surface 16 of the diffusion panel 12.

The light source 20 edge-lights the diffusion panel 12 by emitting light into the diffusion panel 12 through the peripheral edge 14. The diffusion panel 12 receives this light and emits the light through the surface 16. The light source 20 comprises a light emitting diode (LED) array 22, which may be of a linear or matrix form and further comprises multiple LEDs. In one embodiment, the LED is a side firing LED. The peripheral edge 14 comprises a side edge 18 and the light source 20 is located along the side edge 18.

The phosphor layer 30 may be configured to convert a characteristic of the light emitted from the light source 20. For example, the phosphor layer 30 may be used to convert the light emitted from the light source into light having a different wavelength. One example is that the light source 20 may emit non-visible light (light not visible to humans), which is then converted to visible light. In this sense, the phosphor 30 may be thought of as a converter element.

In many applications, it is desired to have an even distribution across the diffusion panel 12 of the conversion effect of the phosphor layer 30. To obtain the even distribution, one may need to consider changes in a characteristic of the light as it passes through the diffusion panel. For example, when it comes to the intensity of the light, it is known that light intensity decreases as a function of the distance the light is from the light source 20. In many cases, the intensity varies inversely related to the square of the distance from the light source.

To compensate for the fall off in the intensity of the light from the light source 20, the phosphor layer 30 may be applied to the diffusion panel to obtain an even distribution of the light characteristic. With regard to the drop off of the intensity of the light across the diffusion panel, the surface area of the phosphor layer 30 may be increased as a function of the distance from the light source 20. More specifically, the area of the phosphor layer 30 may be increased as a function of the square of the distance from the light source 20. In this way, the conversion effect of the phosphor layer 30 is more evenly distributed across the diffusion panel 12.

In the illustrated embodiment, the phosphor layer 30 is applied as a dot pattern 34, with the dots increasing in area as a function of the distance from the light source 20 to affect the increase of the area of the surface 16 covered by the dot pattern 34. The illustrated dot pattern 34 comprises multiple columns 38 of dots 36 and at least some of the dots 36 within a particular column 38 are greater in area than at least some of the dots 36 in another column 38 closer to the light source 20. As shown, one column 38 is distance d₁ from the light source 20 and another column 38 is distance d₂ from the light source 20. The dots 36 which are distance d₂ are larger in area than the dots 36 which are distance d₁ from the light source 20.

In addition to the illustrated dot pattern 34, the dots 36 may vary in pattern, size, shape and density. It is also contemplated that the dots may be of the same size, but that the spacing between the columns is reduced as a function of the distance from the light source 20, which would serve to increase the area of the phosphor layer 30 as a function of the distance from the light source 20. In alternate embodiments, the phosphor layer 30 may comprise a solid layer, striped, or any pattern necessary to diffuse the light from light sources 20 and the dots 36 may be any size or shape, not limited to circles or domes. In the case of multiple light sources 20, the area of the dot pattern may be a function of the superposition of the linear and/or square of the distance to the multiple light sources for each of the dots. Therefore, each light source will have its own linear or square contribution superposed to each other.

The phosphor dots 36 are preferably inkjet-printed onto the surface 16. In alternate embodiments, the method used to deposit phosphor onto the light source 20 may include, but are not limited to, a time-pressure technique or a roller coating technique.

As illustrated, the phosphor layer 30 is a remote phosphor layer. That is, the phosphor layer is physically spaced from the light source 20 and is not in direct physical contact with the light source 20. An advantage of providing the phosphor remote to the light source 20 is that light generation, photo-luminescence, occurs over the entire light emitting surface area of the diffusion panel 12. This can lead to a more uniform color and/or correlated color temperature (CCT) though “hot spots” can still occur in the vicinity of the LEDs, hence, when applicable, the phosphor dots 36 are smallest when closest to the light source 20 and largest when farthest from the light source 20. A further advantage of locating the phosphor remote to the LED is that less heat is transferred to the phosphor, reducing thermal degradation of the phosphor.

The phosphor layer 30 may comprise multiple phosphors, with one or more of the phosphors having a different sensitivity to the received light and thereby converting the received light differently. For example, the different phosphors may convert the light into different colors in addition to converting non-visible light into visible light. By combining different phosphors, either as a single physical element or discrete physical elements, it is possible to convert the original light into a more useful light for the given application. The phosphor layer 30 also diffuses the light to provide uniform light output. Some examples of suitable phosphors include, but are not limited to, copper-activated zinc sulfide, silver-activated zinc sulfide added to a host such as oxides, nitrides, oxynitrides, sulfides, selenides, halides or silicates of zinc, cadmium, manganese, aluminum, silicon, or various rare earth metals. The number of suitable phosphors is practically unlimited and the selected phosphor will be a function of the particular implementation. The phosphor layer 30 may be solely phosphor or made from a mixture of phosphor and other suitable materials.

One advantage of using phosphors for converting the emitted light into an application-specific light source can be found in that a manufacturer need only buy the same type of light source 20 and use the phosphors to convert to the desired light. Therefore, a manufacturer does not have to buy or stock as many different types of light sources 20 to produce varying light colors or effects. The phosphor can generate light of any color or temperature while using a single colored LED, for example.

Referring to FIG. 2, it is illustrated one example of a phosphor layer 30, represented by a single dot, remotely spaced from a light source 20, represented by an LED. When a voltage is applied to the leads of the light source 20, electrons are able to recombine with electron holes within the light source 20, releasing energy in the form of photons thus producing non-visible light waves 70, which travel to the phosphor layer 30, which coverts the non-visible light waves 70 into visible light waves 72 when the light passes through the phosphor layer 30. The phosphor material is operable to absorb at least a part of the light emitted from the light source 20 and in response emit light of a different wavelength. This effect may be used to convert at least one characteristic of the received light into another characteristic, and is applicable to all of the described embodiments.

While the phosphor layer 30 is described as being located on an upper surface of the diffusion panel. It should be noted that the upper surface is relevant to the viewing position. The phosphor layer 30 could just as easily be located on a lower surface. It is contemplated that the phosphor layer could be located within the diffusion panel and not at either the upper or lower surface. For example, the diffusion panel may comprise multiple, stacked panels, with the phosphor layer be located between two of the panels. For practical purposes, the location of the phosphor layer is limited only in that it needs to come between the light source and the viewer.

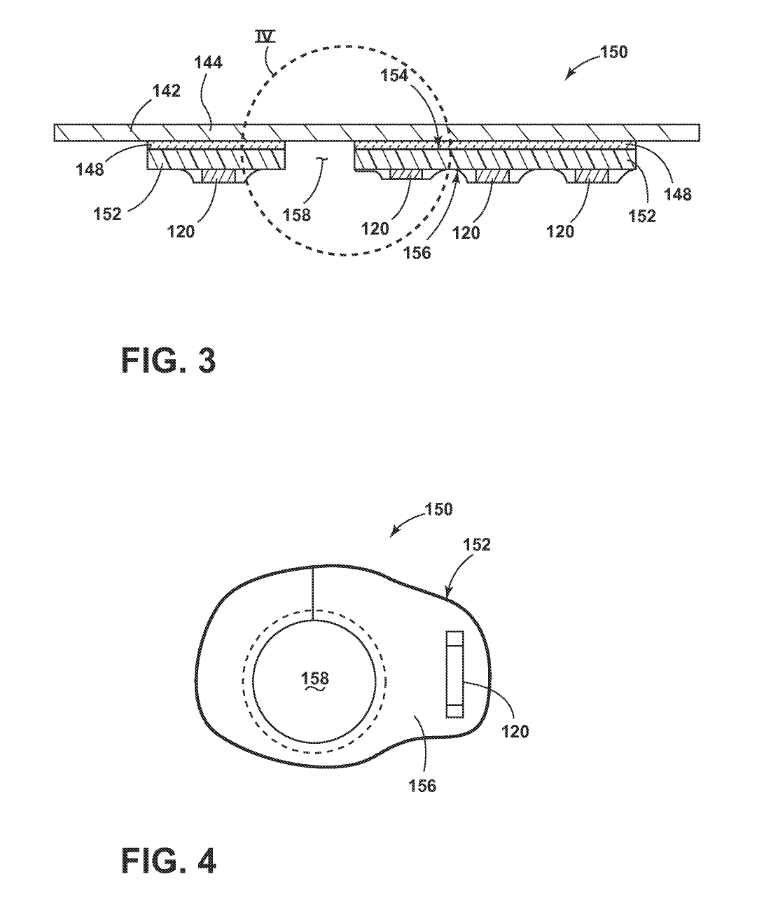

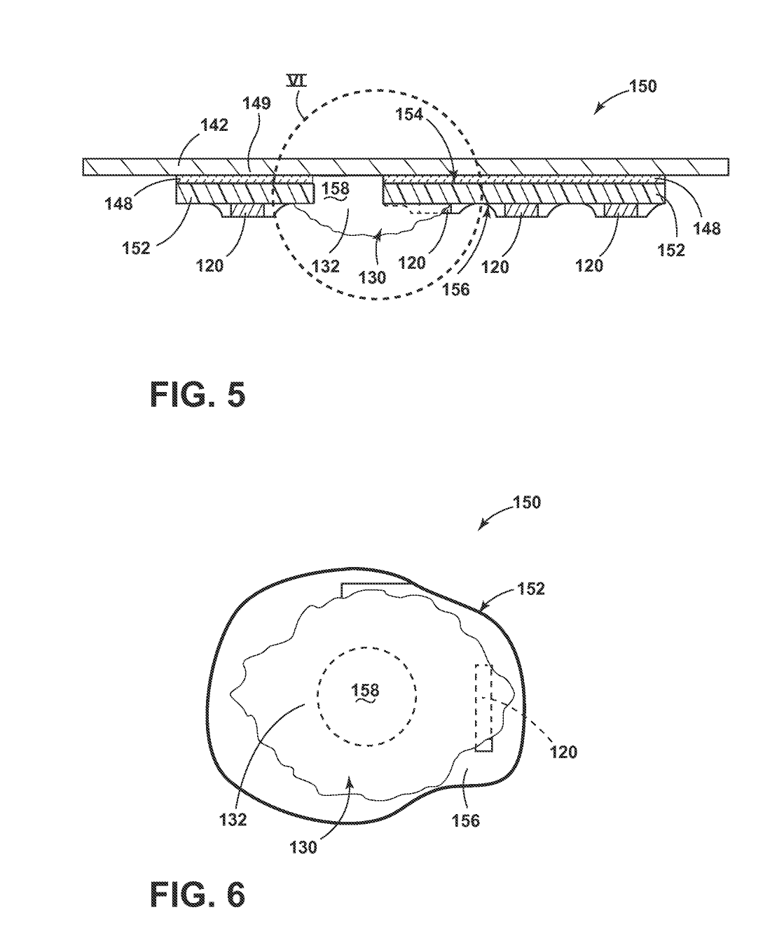

Referring to FIGS. 3-6, a second embodiment illustrating the use of a phosphor 130 as a light guide, in addition to a converter, is shown in the context of a printed circuit board assembly 150. FIGS. 2 and 4 illustrate the printed circuit board assembly without the phosphor 130, while FIGS. 5 and 6 illustrate the printed circuit board assembly with the phosphor 130. Referring to FIG. 3, the basic structure of the printed circuit board assembly 150 is a composite structure formed of a printed circuit board (herein after referred to as “PCB”) 152, an adhesive layer 148, a cover 142, and an indicia layer 144. The adhesive layer 148 bonds together the PCB 152 and the cover 142. The cover 142 protects the PCB 152 and, in some configurations, function as a touch surface for the user interface. The indicia layer 144 provides indicia to a user related to the touch surface. The cover 142 may comprise a transparent material such as a polymer, a polycarbonate, an acrylic or a glass.

The PCB 152 has a first surface 154 and second surface 156. At least one light source 120 may be located on either of the first and second surfaces 154, 156, with the light source being illustrated on the second surface 156 for convenience. The light source 120 may be an LED that emits a non-visible light 170. A through opening 158 extends between the first and second surfaces 154, 156. The through opening 158 is in proximity to the light source 120 and provides a path through which light emitted from the light source 120 may reach the cover 142.

Referring to FIG. 4, the light source 120 may be adjacent the through opening 158. The light source may be a side-firing LED that emits light laterally along the second surface of the PCB 152 toward the through opening 158. It should be noted that it is not necessary that the light source 120 be an LED, let alone a side-firing LED.

Referring now to FIGS. 5 and 6, the phosphor layer 130, which functions as a phosphor light guide 132, has been deposited on the PCB 152 such that it physically overlies the light source 120 and at least a portion of the through opening 158. In this configuration, the phosphor light guide 132 is optically coupled to the light source 120 and converts the non-visible light 170 into visible light 172 in the same manner as aforementioned for FIG. 2, and the phosphor light guide 132 directs the light 170, through the through opening 158, to the cover 142 wherein the visible light 172 leaving the phosphor light guide 132 illuminates the cover 142.

The phosphor light guide 132 may be applied while the phosphor solution is in a semi-solid state in such a way that the PCB 152 may be laminated to the cover 142 and the phosphor solution acts as a bonding agent. Surface mount components installed in the first surface 154 of the PCB 152 may be used as spacers to achieve a desired spacing from the PCB 152 to the cover 142. Wherein the spacing distance is associated to the amount of light diffusion needed. While using such SMD spacing approach the adhesive layer 148 might be partial, therefore covering only a few required locations, or the adhesive might even be absent and the phosphor 130 is used also as the adhering method.

In alternate embodiments, adhesive 148 may be used to adhere the PCB 152 to the cover 142. A touch sensor element (not shown) may be mounted to the PCB 152 as an unmasked pad in such a way that the metallic look of this pad acts as a minor to improve light reflection towards the cover 142. The pad may be plated with a metal or paint with a high reflection coefficient, i.e. white paint, solder metal, metalized sticker, etc.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

We claim:

1. A backlight assembly comprising:
a diffusion panel having a peripheral edge and a surface;
a light source located on a portion of the peripheral edge and emitting light into the diffusion panel through the peripheral edge and emitted through the surface;
a layer provided on the panel in the form of a pattern of dots formed of a material comprising phosphor, wherein the area of the diffusion panel covered by the dot pattern increases as a function of the distance from the light source.

2. The backlight assembly of claim 1 wherein the area of the dots forming the dot pattern increase as a function of the distance from the light source to effect the increase of the area of the panel covered by the dot pattern.

3. The backlight assembly of claim 2 wherein the dot pattern comprises multiple columns of dots and at least some of the dots within a particular column are greater in area than at least some of the dots in another column closer to the light source.

4. The backlight assembly of claim 2 wherein the area of the dots increases proportionally to the distance the dots are from the light source.

5. The backlight assembly of claim 2 wherein the area of the dots increases proportionally to the square of the distance the dots are from the light source.

6. The backlight assembly of claim 1 wherein the function is at least one of proportional to the distance from the light source or proportional to the square of the distance from the light source.

7. The backlight assembly of claim 1 wherein the at least one light source comprises multiple light sources and the function is proportional to a superposition of the linear distance from the multiple light sources or the superposition of the square of the distance from the multiple light sources.

8. The backlight assembly of claim 1 wherein the peripheral edge comprises a side edge and the light source is located along the side edge.

9. The backlight assembly of claim 1 wherein the light source comprises an LED array.

10. The backlight assembly of claim 1 wherein the light source emits non-visible light and the phosphor layer converts the non-visible light to visible light.

11. The backlight assembly of claim 1 wherein the surface comprises at least one of an upper surface or a lower surface of the diffusion panel, with the pattern of dots being provided on one of the at least one of the upper surface and lower surface.

12. A printed circuit board (PCB) assembly comprising:
a printed circuit board having opposing first and second surfaces;
a light source provided on one of the first or second surfaces and emitting a non-visible light; and
a phosphor light guide optically coupled to the light source to convert the non-visible light into visible light.

13. The PCB assembly of claim 12 further comprising a cover overlying the PCB and the phosphor light guide directs the visible light to the cover.

14. The PCB assembly of claim 13 wherein the cover transmits at least a portion of the visible light.

15. The PCB assembly of claim 13 wherein the PCB has a through opening extending between the first and second surfaces, the light source is mounted to the second surface, and the phosphor light guide directs light through the through opening.

16. The PCB assembly of claim 15 wherein the cover overlies the first surface.

17. The PCB assembly of claim 16 wherein the phosphor light guide is provided within the through opening.

18. The PCB assembly of claim 16 wherein the light source is a side-firing LED or a top-firing LED.

19. The PCB assembly of claim 12 wherein the PCB has a through opening extending between the first and second surfaces and the light guide is provided in the through opening.

20. The PCB assembly of claim 19 wherein the light source is mounted to the second surface, and the phosphor light guide directs light through the through opening beyond the first surface.
